(19) United States
(12) Patent Application Publication
(10) Pub. No.: US 2026/0001365 A1
(43) Pub. Date: Jan. 1, 2026

(54) DIGITAL PRINTING ON A WOOD-BASED SUBSTRATE FOR EXTERIOR APPLICATION

(71) Applicant: LOUISIANA-PACIFIC CORPORATION, NASHVILLE, TN (US)

(72) Inventors: JARROD KEVIN LINE, BRENTWOOD, TN (US); SARATH VEGA-GUTIERREZ, NASHVILLE, TN (US)

(21) Appl. No.: 19/322,308

(22) Filed: Sep. 8, 2025

Related U.S. Application Data
(63) Continuation-in-part of application No. 16/991,994, filed on Aug. 12, 2020, now Pat. No. 12,409,637.
(60) Provisional application No. 62/885,329, filed on Aug. 12, 2019.
(60) Provisional application No. 63/786,841, filed on Apr. 10, 2025.

(51) Int. Cl. B41M 5/00; B32B 21/06; B41J 3/28; B41J 3/407; B41J 11/00; B41M 3/00; B41M 7/00; G01B 21/30

(52) U.S. Cl. CPC B41M 5/0047; B32B 21/06; B41J 3/28; B41J 3/407; B41J 11/00214; B41J 11/0095; B41M 3/008; B41M 5/0017; B41M 5/0064; B41M 7/0045; B41M 7/0081; G01B 21/30; B32B 2250/02; B32B 2255/12; B32B 2260/028; B32B 2260/046

(57) ABSTRACT

A system and related methods for high-resolution digital printing on wood-based substrates for exterior applications or outdoor use. Textured wood-based substrates include, but are not limited to, plywood, wood planks, oriented-strand board (OSB), laminated strand lumber (LSL), laminated veneer lumber (LVL), paper board, and various forms of engineered wood. A manufactured or engineered wood product with an engineered orientation is used as the base substrate to minimize deformation. A resin-impregnated paper overlay, which may include a special adhesion-promoting primer layer, is placed on the surface that will be subject to exposure outdoors. An image or images are printed using UV-resistant inks or film coatings, and a protective layer applied over the printed ink. The elasticity of the ink or film coating and the protective layer should match the protective overlay.

This application is a continuation-in-part application of U.S. patent application Ser. No. 16/991,994, filed Aug. 12, 2020, subsequently issued as U.S. Pat. No. 12,409,637, issued Sep. 9, 2025, which claims benefit of and priority to U.S. Provisional Application No. 62/885,329, filed Aug. 12, 2019; this application also claim benefit of and priority to U.S. Provisional Application No. 63/786,841, filed Apr. 10, 2025; all of the above references are incorporated herein in their entireties by specific reference for all purposes.

### FIELD OF INVENTION

This invention relates to a system and related methods for digital printing on a wood-based substrate, including but not limited to engineered wood, for exterior application or outdoor use.

### BACKGROUND OF INVENTION

Prior art exterior wood products have required repeated and regular refinishing to maintain their aesthetic quality. Naturally-durable wood products such as cedar and redwood have been used for the exterior cladding of homes for hundreds of years. Over time natural deformation of the wood, driven by shrinking and swelling from free moisture, tended to compromise finishes, and thus this type of cladding requires repeated refinishing to maintain desirable aesthetics. Engineered wood products such as plywood experience similar issues with swelling and shrinking, though perhaps at different rates than natural wood. Wood-based products will continue to deform, even at the fiber level, unless the surface can be stabilized.

Typical decay treatments would slow down or stop decay, but not change the natural deformation of the surface. These treatments serve more to stop or slow the growth of fungi rather change the water absorption characteristics of the wood. Water impervious treatments such as paraffin waxes and film forming finishes would serve to slow the surface decay affects and extend service life, though themselves would not greatly extend the aesthetic performance and generally required great effort to refinish in the field.

A further complication with wood products, even engineered wood products is that the wood fiber is typically able to take on only certain types of finishes. The high absorbency of the wood fiber required a finish with high content of water or volatile organics and a process to drive off the liquid carrier.

Other methods have been employed to create a wood fiber-based substrate which was more resistant to shrinking and swelling. Chemical methods such as phenol formaldehyde impregnation typically required significant amounts of resin to be forced into the dried wood product in an industrial setting, then a second drying process to drive off the water carrier. While successful in reducing deformation of wood products treatments are often extremely costly and have downsides with manufacturing and emissions control.

With the expectation of deformation, wood finishes are largely limited to non-film forming colorants and dyes or film forming highly flexible finishes. A stain usually highlights the existing wood grain, or a paint provides a heavy film that tend to be a very simple, mono-tone finish. The colorant and dyes tend to color the wood fiber and are very susceptible to UV fade which require frequent maintenance. Film forming finishes tend to break down due to deformation of the wood which breaks the film barrier and again requires maintenance.

A second problem for the application of film forming and decorative finishes is the adhesion to the wood fiber itself. Adhesion directly to the fiber is for the most part mechanical in nature. Since the wood will be deforming at the fiber level, mechanical bonds will begin to breakdown as the fibers change shape relative to each other. Over time this will loosen even the strongest adhesive or finish and, in some cases, the remaining adhesion will separate the fiber from the main body of the wood resulting in tear-out.

Surface deformation on wood products as discussed above continues to cause significant challenges to the long-term durability of high value finishes, such as ink jet printing, in exterior applications. Materials such as plastic (e.g., HDPE for decking, PVC for fencing, and the like) and aluminum siding have been used extensively with decorative finishes such as pre-printed films and direct-to-substrate printing. However, these techniques used on metal or plastic substrates will not work on wood products. Accordingly, there continues to be a need for a system and method for high-resolution printing on wood-based substrates for exterior application or outdoor use.

### SUMMARY OF INVENTION

In various exemplary embodiments, the present invention comprises a system and related methods for high-resolution digital printing on wood-based substrates for exterior application or outdoor use. Textured wood-based substrates include, but are not limited to, plywood, wood planks, oriented-strand board (OSB), laminated strand lumber (LSL), laminated veneer lumber (LVL), paper board, and various forms of engineered wood. The present invention allows the high-quality duplication of the aesthetic and textural features of a particular type or style of board or panel on the substrate, or printing of an image or images on the substrate.

The present invention addresses the above problems with a manufactured or engineered wood product that is used as the base substrate. The engineered wood product comprises wood fibers with an engineered orientation (along with resin as a binder), which minimizes the deformation of the wood in certain orientations. A resin-impregnated paper overlay is then applied (typically during the manufacturing process or during finishing) over the engineered wood substrate. In one embodiment, the paper overlay is a medium density resin-impregnated paper overlay. The combination of the oriented substrate and the paper overlay provides an ideal surface for application of printed images subject to exposure outdoors. In a further embodiment, the paper overlay may be impregnated with an additional primer layer.

In several additional embodiments, the ink used for printing is formulated for outdoor use. The ink may be a plurality of UV-resistant inks applied to the surface with a variety of printing technologies (e.g., transfer, rotogravure and/or ink jet systems). A clear or transparent protective layer also may be applied over the printed ink on the surface. This protective layer may be in solid form (e.g., film overlay) or liquid form (e.g., liquid coating). In several embodiments, the protective layer may be applied during and/or after the printing process.

The image or images printed can be in any form, and may include drawings, pictures, scanned images (modified and unmodified), photographs, letters, words, numbers, icons or other forms of graphic images, or combinations thereof. For example, the image may be obtained from a high-resolution scan of a board, wood or other surface, or image to be duplicated. The scan data is stored in an electronic data file, and may be modified, if desired, including, but not limited to, the addition of custom foreground or background images. The scanned image is not limited to wood, and any material (e.g., brick, stone, or the like) or image can be replicated on the substrate. The image is then printed on one or more substrates prepared as described above in a production line using a large-scale production printer. The printing duplicates the image and also can add texture and depth, based on the thickness of ink applied. The finished product may be specially packaged.

### BRIEF DESCRIPTION OF THE DRAWINGS

FIG. 1 shows a view of a system in accordance with an exemplary embodiment of the present invention.

FIG. 2 shows a view of a multi-layered wood-substrate product for exterior use in accordance with an exemplary embodiment of the present invention.

FIG. 3 shows a cross-section view of a multi-layered wood-substrate product with digital printing for exterior use in accordance with another exemplary embodiment of the present invention.

FIGS. 4-8 show top views of pieces of siding with digital printing in accordance with exemplary embodiments of the present invention.

### DETAILED DESCRIPTION OF EXEMPLARY EMBODIMENTS

In various exemplary embodiments, the present invention comprises a system and related methods for high-resolution digital printing on wood-based substrates for exterior application or outdoor use. Textured wood-based substrates include, but are not limited to, plywood, wood planks, oriented-strand board (OSB), laminated strand lumber (LSL), laminated veneer lumber (LVL), paper board, and various forms of engineered wood. The present invention allows the high-quality duplication of the aesthetic and textural features of a particular type or style of board or panel on the substrate, or printing of an image or images on the substrate. The engineered wood substrate and product 2 can be of any type used in an exterior application, including, but not limited to, fencing, fence panels, fence pickets, fence posts or other components, decking, deck planks, deck beams, deck posts, deck beams or other components, siding or siding components, roofing or roofing components, exterior doors, outdoor posts or supports, and the like.

Printing images onto wood products has been limited to interior applications since wood will tend to shrink and swell (and warp) in exterior conditions (i.e., outdoors), thereby causing the image to distort and/or break. The movement is caused by the gain and loss of moisture, which causes the swelling and shrinking (respectively) of the wood fiber. This translates into gross swell as well as deformation of the wood product. While non-wood products have been used in exterior applications, wood or engineered wood is less expensive and provides a more authentic look and feel as compared to non-wood products.

The present invention addresses the above-described problems with a manufactured or engineered wood product that is used as the base substrate. A class of engineered-wood products are multilayer oriented wood strand particleboards, particularly those with a layer-to-layer oriented strand pattern, such as “OSB”. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,425,976, 5,470,631, 5,525,394, 5,718,786, and 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers.

The engineered wood substrate 10 of the present invention 2 comprises wood fibers or flakes with an engineered orientation (along with resin as a binder), which minimizes the deformation of the wood in certain orientations. The natural behavior of the wood to deform along the grains is greatly reduced by the wood construction of the engineered wood-based board or product. Whereas in the past, wood-based boards largely left the wood fiber intact throughout the manufacturing process, the engineered wood product construction used for the present invention greatly reduces the gross deformation of the product and randomizes the remaining deformation 62. Swelling in the resulting engineered-wood product is uniform in all orientations of the wood.

A resin-impregnated paper overlay 20 is then applied 64 (typically during the manufacturing process or during finishing) over the engineered wood substrate 10. This overlay is relative rigid and water-resistant base layer that acts as a relatively non-deformable surface for the application of film-forming coatings. An adhesion-promoting primer 20 is applied to, or is present on, the outer or upper surface of this paper overlay. The primer must be compatible with the particular inks 30 being used, as described below. The resin impregnated paper 20 with adhesion-promoting primer 30 acts as a stable substrate for the application of film forming finishes, and the paper-primer combination provides uniform adhesion surface. The combination of the oriented substrate 10 and the paper overlay 20 thus provides an ideal surface for application of printed images or printed decorative surfaces subject to exposure outdoors. In one embodiment, the paper overlay is a medium density resin-impregnated paper overlay.

In several embodiments, the paper overlay 20 may already be impregnated with a primer layer 30 prior to being attached to the engineered wood substrate 10. In this embodiment, no additional primer layer may be needed, although in some embodiments, a second primer layer may be applied 66 as well to the integrated/impregnated primer layer (i.e., effectively providing a double primer layer).

Ink jet printer coatings for the printed layer 30 are applied in a high solids content, typically UV-cured coating direct to the primed paper. These coatings are typically applied with 4-6 colors layers ranging from CMYK (Cyan, Magenta, Yellow, Black) to CMYKOG (Cyan, Magenta, Yellow, Black, Orange, Green), and can be composed of organic or inorganic inks. In several additional embodiments, the ink used for printing is formulated for outdoor use. The ink may be a plurality of UV-resistant inks applied 68 to the surface with a variety of printing technologies (e.g., transfer, rotogravure and/or ink jet systems).

At present, organic inks provide shorter lives for UV exposures as compared to the inorganic inks. With the longer-life inorganic inks some of the brightness of colors is sacrificed. In several embodiments, viscosity should be in the range of 4 to 8 mPa, for use with printer heads using picoliters. Curing techniques include air drying and/or UV-radiation (e.g., UV-lamps), with the duration and intensity depending on the particular ink. Curing often is built into the printing system itself. Metal based inks or powder coats may be used. In such cases, heat curing may be required.

A durable, clear or transparent protective layer 40 may be applied 70 over the printed ink layer on the surface. This protective layer 40 may be in solid form (e.g., film overlay) or liquid form (e.g., liquid coating). In various embodiments, the protective layer may be applied during and/or after the printing process, such as by jetting (printing), brushing, spraying, flood coating, and the like. The protective layer protects the printed surface from UV-light damage (i.e., the protective layer protects the underlying printed ink from UV-exposure, or reduces that exposure) as well as mechanical damage. Ink as it is applied is fragile, so a UV-cured top coating composed of one of several chemistry systems (e.g., acrylic, silicone, melamine, polyurethane) enhances the life of the product. Solid protective layers may comprise different polymers, and are applied once the printed surface has fully cured. The thickness of the protective layer is correlated with the expected service life of the resulting product.

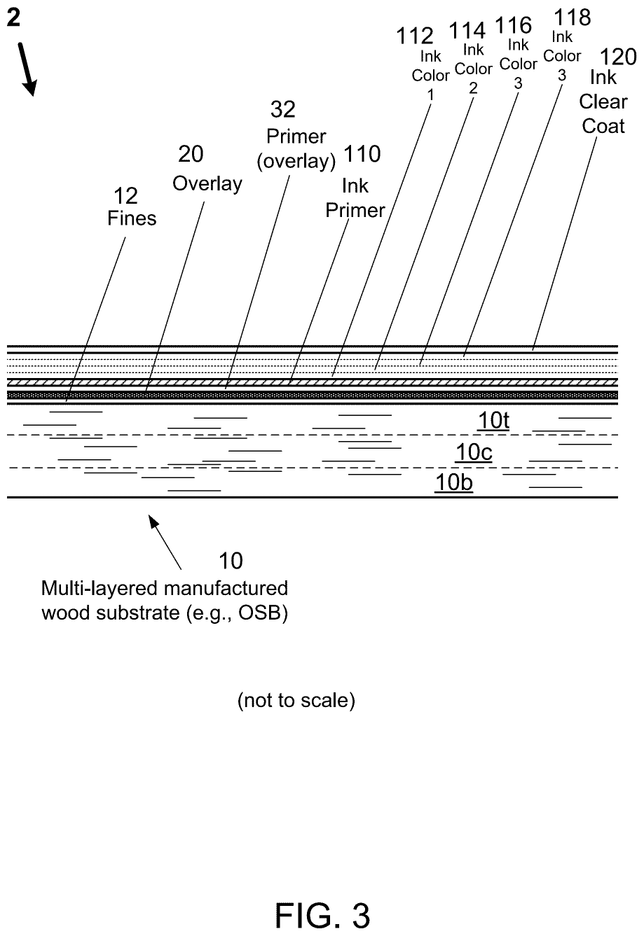

FIG. 3 shows another embodiment of the present invention detailing the sequential application of inks. The resin-impregnated paper overlay 20 is applied (typically during the manufacturing process or during finishing) over the engineered wood substrate 10 material. This overlay is relative rigid and has a water-resistant base layer that acts as a relatively non-deformable surface for the application of paint layers, powder-coatings, and/or protective coatings. A primer 32 is applied to, or is present on, the outer or upper surface of this paper overlay. In several embodiments, the primer is pre-applied to the paper overlay before the primed overlay is placed on the top of the strand mat (i.e., bottom strands 10b, core strands 10c, top strands 10t, and a fines layer 12, if any) pre-press.

In additional embodiments, an optional paint or coating layer may be applied post-press to the top surface of the primed overlay. The paint may be an acrylic paint. The coating may be a powder coating. A system and method of applying a powder coating to a manufactured wood product post-press is disclosed in U.S. patent application Ser. No. 19/050,027, filed Feb. 10, 2025, which is incorporated herein in its entirety by specific reference for all purposes.

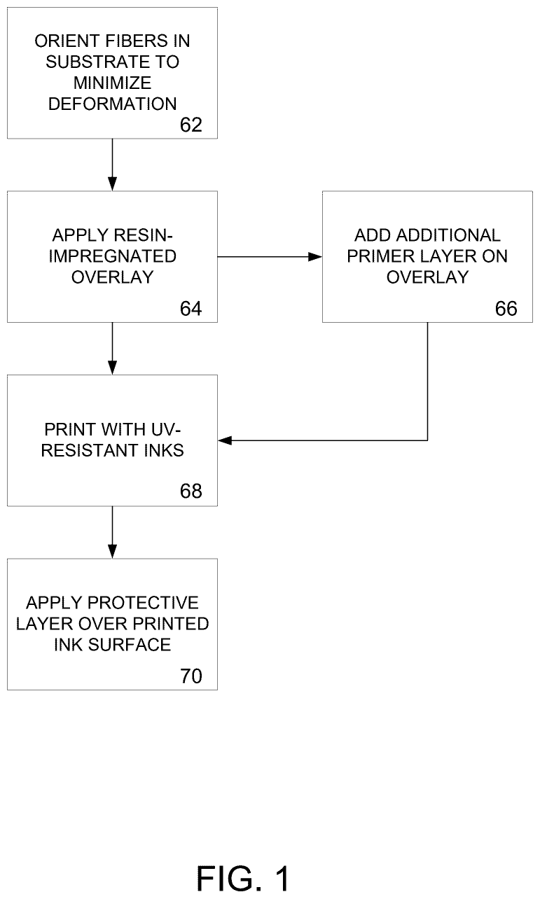

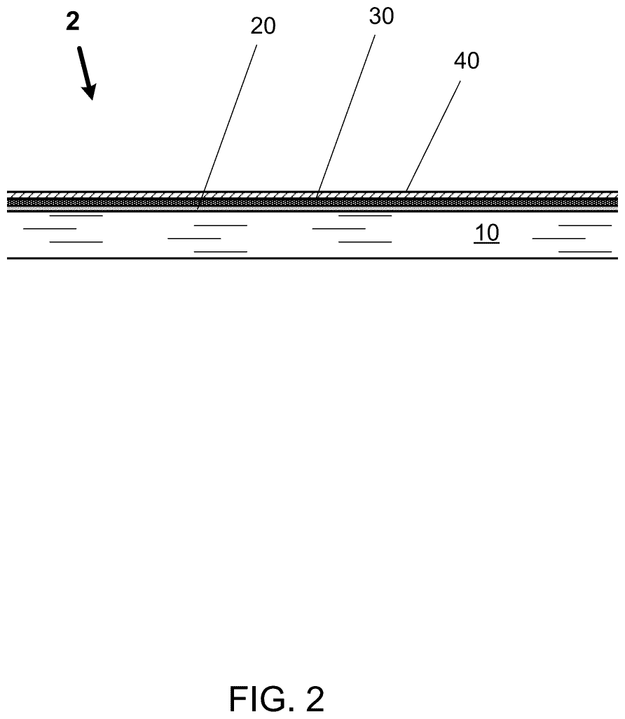

The engineered-wood boards and/or panels with primed overlay, and with or without the optional paint or coating layer, subsequently go through a digital printing process described below and as seen in FIG. 1. This may occur in the same facility as the processes described above, or may occur in a separate building or facility. The boards and/or panels pass through or under an industrial digital printer with multiple print heads and curing lights that performs the following steps in a continuing sequence as the boards/panels pass through:
1. An ink primer 110 is applied.
2. The ink primer is cured, typically by a primer-curing UV light.
3. A first ink color 112 is applied by a first ink print head.
4. The first ink color is cured by a first UV light.
5. A second ink color 114 is applied by a second ink print head.
6. The second ink color is cured by a second UV light.
7. A third ink color 116 is applied by a third ink print head.
8. The third ink color is cured by a third UV light.
9. A fourth ink color 118 is applied by a fourth ink print head.
10. The fourth ink color is cured by a fourth UV light.
11. An ink clear coat 120 is applied.
12. The ink clear coat is cured by a clear coat UV light.

After the ink clear coat 120 is cured, the entire board/panel is subjected to a full cure with another UV light. The UV light activates binders in the inks and related components described above for curing. The inks also are UV resistant (i.e., resistant to fading from exposure to UV light over a long period of time).

The four ink colors are some combination of Cyan (C), Magenta (M), Yellow (Y) and Black (K). In one exemplary embodiment, the colors of ink are applied in the order of C, M, Y and K, although different color orders may be used. Further, different and/or additional colors may be used. The appearance of a color may be affected by the color or appearance of the underlying primed overlay substrate and/or any paint or powder coating used.

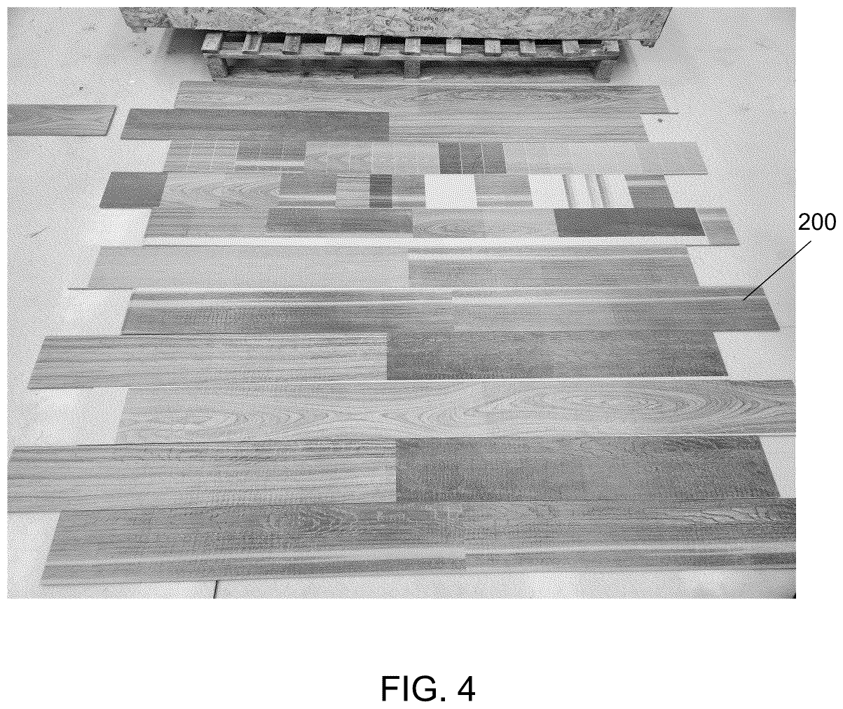

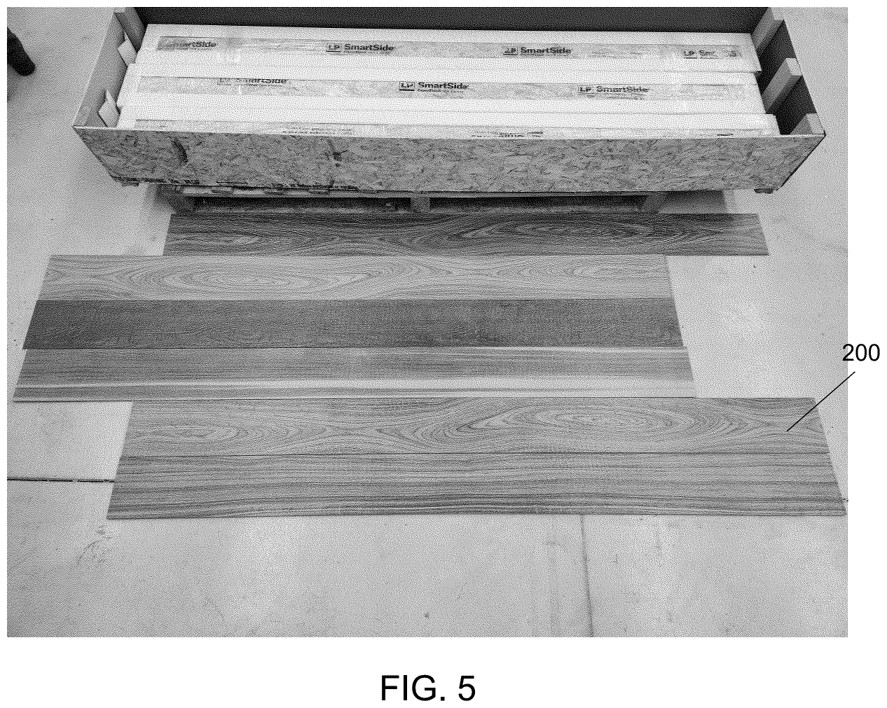

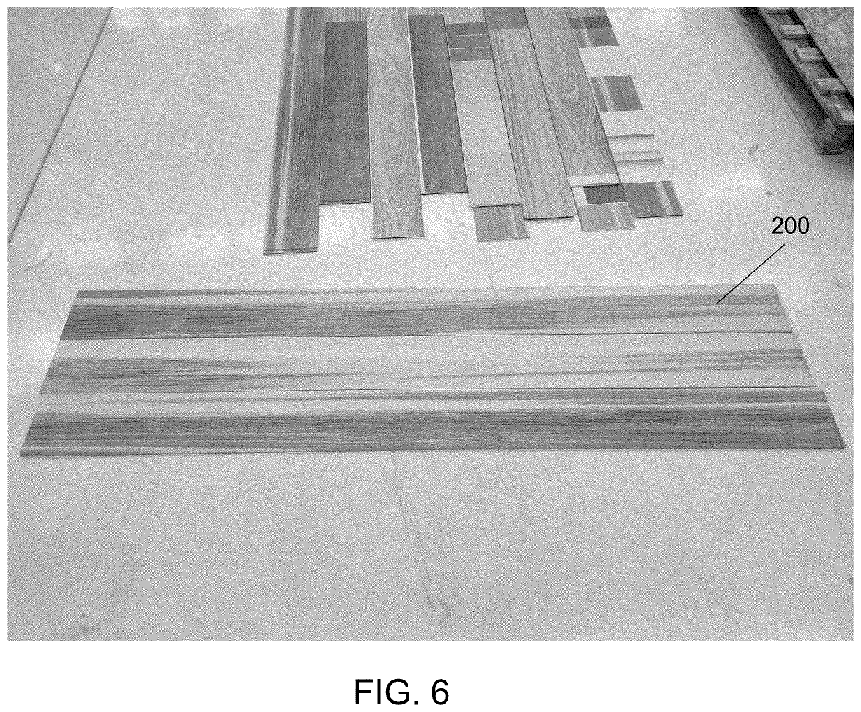

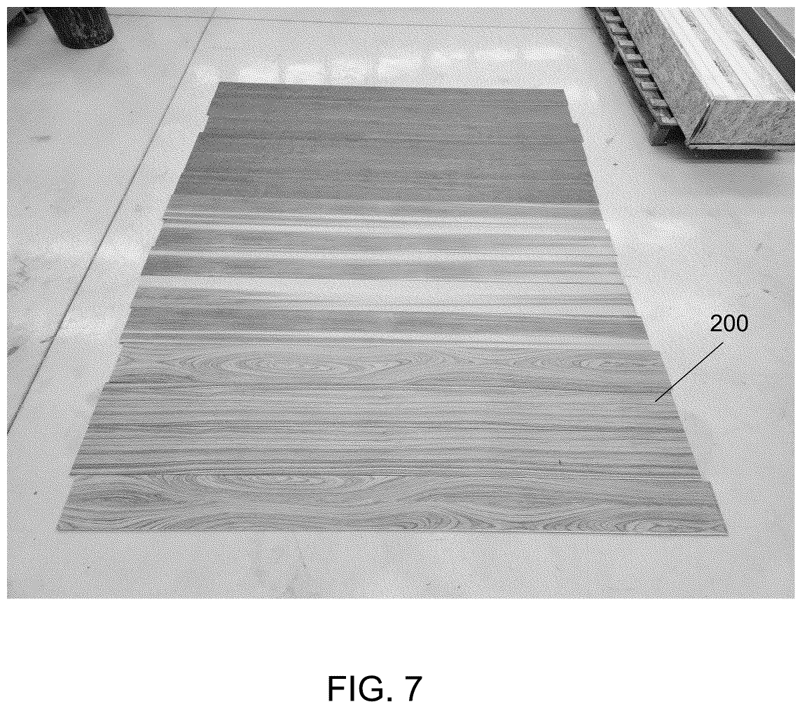

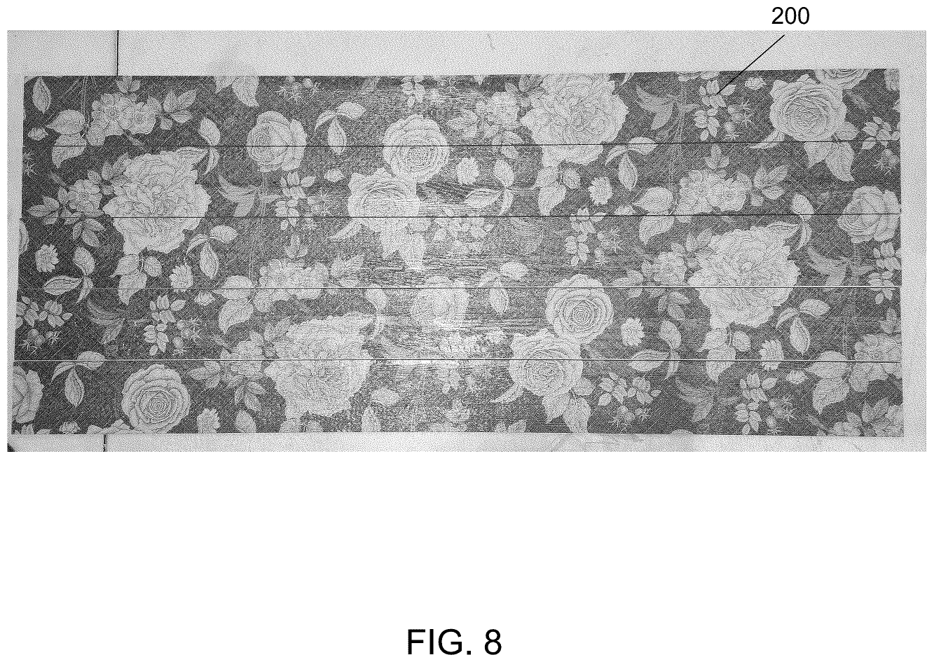

The inks are applied to the surface of the board/panel to print images or patterns 200 as programmed, including, but not limited to, wood grain patterns, masonry, brick, words, pictures, logo, and other forms of patterns or images, or combinations thereof. Examples are seen in FIGS. 4-9. In one exemplary embodiment, the boards/panels are pressed with a cedar or other wood texture imparted to the top surface by an embossment on the top press platen. The printed images may print wood grain patterns or images that correspond to or enhance the cedar texture or other texture in some way, including adding shading, highlights, wood knots, defects, or similar enhancements.

In additional embodiments, the system may scan the surface of the board or panel before printing to identify the presence and topography of any embossed cedar or other texture, and adjust the printing of the inks to match the embossed texture, as described above. Alternatively, the system may have a digital map of the entirety of the texture pattern (i.e., the entire texture pattern on a press platen), and then scanning portions (e.g., a portion of the ends) or all of the board or panel to first determine what portion of the texture digital map is present on the surface of the board or panel, and then make adjustments based on that determination.

After curing of the entire board/panel, a protective coating may be applied to prevent abrading, scratching, or other damage to the printed layers. The protective coating is a clear coating, such as, but not limited to, an acrylic clear coat or a polyurethane clear coat. In some embodiments, a protective coating is not applied, such as when there is limited or lower exposure.

A durable, clear or transparent protective layer may be applied over the printed ink layer on the surface. This protective layer may be in solid form (e.g., film overlay) or liquid form (e.g., liquid coating). In various embodiments, the protective layer may be applied during and/or after the printing process, such as by jetting (printing), brushing, spraying, flood coating, and the like. The protective layer protects the printed surface from UV-light damage (i.e., the protective layer protects the underlying printed ink from UV-exposure, or reduces that exposure) as well as mechanical damage. Ink as it is applied is fragile, so a UV-cured top coating composed of one of several chemistry systems (e.g., acrylic, silicone, melamine, polyurethane) enhances the life of the product. Solid protective layers may comprise different polymers, and are applied once the printed surface has fully cured. The thickness of the protective layer is correlated with the expected service life of the resulting product.

In several embodiments, the primer may be adhesion-promoting, and the overlay with primer layer thus acts as a stable substrate for the application of film forming finishes, with the paper-primer combination providing a uniform adhesion surface. The combination of the oriented substrate and the paper overlay thus provides an ideal surface for application of printed images or printed decorative surfaces subject to exposure outdoors. In one embodiment, the paper overlay is a medium density resin-impregnated paper overlay.

In several embodiments, the paper overlay may already be covered or impregnated with a primer layer prior to being attached to the engineered wood substrate. In this embodiment, no additional primer layer may be needed, although in some embodiments, a second primer layer may be applied as well to the integrated/impregnated primer layer (i.e., effectively providing a double primer layer). This second primer layer may be separate from the ink primer applied by the continuous, sequential digital printing process described above.

Ink jet printer coatings for the printed layer(s) may be applied in a high solids content, typically UV-cured coating direct to the primed paper overlay. These coatings are typically applied with 4-6 colors layers ranging from CMYK (Cyan, Magenta, Yellow, Black) to CMYKOG (Cyan, Magenta, Yellow, Black, Orange, Green), and can be composed of organic or inorganic inks. In several additional embodiments, the ink used for printing is formulated for outdoor use. The ink may be a plurality of UV-resistant inks applied to the surface with a variety of printing technologies (e.g., transfer, rotogravure and/or ink jet systems).

At present, organic inks provide shorter lives for UV exposures as compared to the inorganic inks. With the longer-life inorganic inks some of the brightness of colors is sacrificed. In several embodiments, viscosity should be in the range of 4 to 8 mPa, for use with printer heads using picoliters. Curing techniques include air drying and/or UV-radiation (e.g., UV-lamps), with the duration and intensity depending on the particular ink. Curing often is built into the printing system itself. Metal based inks or powder coats may be used. In such cases, heat curing may be required.

In several embodiments, the elasticity of the ink or ink film and/or the protective layer or film (after drying or curing) should substantially match or closely approximate the paper overlay elasticity (measured by the modulus of elasticity or Young's modulus). In one embodiment, a liquid protective layer has to remain elastic enough to bear up to 10% of surface elongation. In several embodiments, the Young's modulus/modulus of elasticity for the printed ink layer is within 10% of that for the paper overlay. In additional embodiments, the Young's modulus/modulus of elasticity for the protective layer is within 10% of that for the paper overlay.

The image or images printed can be in any form, and may include drawings, pictures, scanned images (modified and unmodified), photographs, letters, words, numbers, icons or other forms of graphic images, or combinations thereof. For example, the image may be obtained from a high-resolution scan of a board, wood or other surface, or image to be duplicated. The scan data is stored in an electronic data file, and may be modified, if desired, including, but not limited to, the addition of custom foreground or background images. The scanned image is not limited to wood, and any material (e.g., brick, stone, or the like) or image can be replicated on the substrate. The image is then printed on one or more substrates prepared as described above in a production line using a large-scale production printer. The printing duplicates the image and also can add texture and depth, based on the thickness of ink applied. The finished product may be specially packaged.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of producing an exterior-use engineered-wood product, comprising the steps of:
providing a rectilinear base layer comprising engineered wood formed from one or more layers of treated wood strands or flakes;
applying a resin-impregnated paper overlay layer fully impregnated with resin on a first surface of the base layer;
providing a first primer layer as part of or attached to the resin-impregnated paper overlay layer;
applying an ink primer layer to an upper surface of the first primer layer;
curing the ink primer layer by a primer-curing UV light;
applying a first ink with a first color by a first ink print head to an upper surface of the ink primer layer;
curing the first ink by a first UV light;
applying a second ink with a second color by a second ink print head;
curing the second ink by a second UV light;
applying a third ink with a third color by a third ink print head;
curing the third ink by a third UV light;
applying a fourth ink with a fourth color by a fourth ink print head;
curing the fourth ink by a fourth UV light;
applying an ink clear coat;
curing the ink clear coat by a clear coat UV light; and
after the curing of the ink clear coating, fully curing all layers with a final UV light.

2. The method of claim 1, wherein the inks comprise inorganic inks.

3. The method of claim 1, wherein the base layer comprises oriented strand board.

4. The method of claim 1, further comprising the step of applying a coating layer to the upper surface of the primed overlay layer, prior to applying the ink primer layer.

5. The method of claim 1, wherein the elasticity of the ink layers and the ink clear coating layer are approximately equal to the elasticity of the paper overlay layer.

6. The method of claim 1, wherein at least one of the inks comprises a UV-resistant ink.

7. The method of claim 1, wherein the first ink, second ink, third ink, and fourth ink are UV-resistant inks.

8. The method of claim 1, wherein the ink clear coat is UV resistant.

9. The method of claim 1, further comprising the steps of:
scanning the first surface of the base layer to identify the presence and topography of any physical texture on the first surface; and
adjusting the steps of printing of the inks to correspond to the physical texture.

10. The method of claim 9, wherein the physical texture is a cedar texture or other wood texture embossed in the first surface.

11. The method of claim 10, wherein adjusting the steps of printing of the inks comprising printing one or more images or patterns on the first surface that correspond to or enhance the embossed texture.
